(19) United States
(12) Patent Application Publication
(10) Pub. No.: US 2018/0208098 A1
(43) Pub. Date: Jul. 26, 2018

(54) DOCKING APPARATUS

(71) Applicant: Ford Global Technologies LLC, Dearborn, MI (US)

(72) Inventors: Vic Kong, Nanjing (CN); Wei Xu, Nanjing (CN); Peter Zhang, Nanjing (CN); Brick Deng, Nanjing (CN)

(21) Appl. No.: 15/866,822

(22) Filed: Jan. 10, 2018

(30) Foreign Application Priority Data
Jan. 20, 2017 (CN) 201710040765.1

(51) Int. Cl. B60P 3/07; B60R 9/06; B60R 9/10

(52) U.S. Cl. CPC B60P 3/07; B60R 2011/0015; B60R 9/10; B60R 9/065

(57) ABSTRACT

The present disclosure provides a docking apparatus for receiving an article. The docking apparatus includes a mounting bracket; and a docking assembly pivotally connected to the bracket. The docking assembly includes a first base bracket and a second base bracket moveable relative to the first base bracket. The first base bracket has a first receiving slot and the second bracket has a second receiving slot.

### RELATED APPLICATION

This application claims the benefit of Chinese Patent Application No.: CN 201710040765.1 filed on Jan. 20, 2017, the entire contents thereof being incorporated herein by reference.

### FIELD

The present disclosure relates to a docking apparatus to hold an article and a docking apparatus pivotally connected to a structure member.

### BACKGROUND

Finding a parking lot can be difficult in a city. Various solutions come up to address the last mile issue. For example, some drivers place a personal transportation device such as a two-wheeler in a trunk of a vehicle, park the vehicle in a location away from a destination and then ride the personal transportation device to the destination from the parking lot. The personal transportation device needs to be secured in the trunk when the drivers drive the vehicle to avoid the movement and noises. The personal transportation device can be an electric bike and an electric scooter. A tether is commonly used to fix the e-bike or e-scooter. However, it is difficult to firmly secure the e-bike or e-scooter via a flexible connection. Thus, there is a need for a docking device to secure the personal device in a trunk of a vehicle.

### SUMMARY

According to one aspect of the present disclosure, a docking apparatus is provided to receive an article. The docking apparatus comprises a docking assembly to be pivotally connected to a mounting bracket. The docking assembly includes a first base bracket and a second base bracket moveable relative to the first base bracket. The first base bracket includes a first receiving slot, and the second base bracket includes a second receiving slot.

In one embodiment, the docking assembly may be connected to the mounting bracket via a pivotal pin.

In another embodiment, the docking assembly may further comprise an electric motor positioned within the first base bracket and connected to the pivotal pin to drive the docking assembly.

In another embodiment, the first base bracket may be connected with the second base bracket via a pair of retractable guiding rails such that the second base bracket is movable between a retracted position and an extended position away from the retracted position along a lengthwise direction.

In another embodiment, the first base bracket may include a first base and a first supporting portion positioned on the first base. The first receiving slot may be positioned on the first supporting portion.

In another embodiment, the first base may further include a pair of longitudinal rails and a pair of lateral rails connecting with the pair of longitudinal rails.

In another embodiment, the first supporting portion may include a main body and a pair of arms extending from the main body. The main body and the pair of arms may define a receiving opening and the second base bracket is at least partially received in the receiving opening at the retracted position.

In another embodiment, the second base bracket may include a second base and a second supporting portion pivotally connected to the second base. The second supporting portion may be pivoted to a second position at an angle from a first position, and the second supporting portion may include a first surface and the second receiving slot is recessed from the first surface.

In another embodiment, the second supporting portion may further include a second surface opposing to the first surface and a third receiving slot recessed the second surface.

In another embodiment, the second receiving slot and the third receiving slot may differ in size.

In another embodiment, the docking assembly may further comprise a panel positioned at the bottom of the first base bracket.

According to another aspect of the present disclosure, a docking apparatus to hold an article in a vehicle is provided. The docking apparatus comprises a mounting bracket; and a docking assembly pivotally connected to the mounting bracket. The docking assembly may pivot between a folded position adjacent to a seatback and an unfolded position adjacent to a trunk floor, and include a first base bracket and a second base bracket moveable relative to the first base bracket along a lengthwise direction such that a length of the docking assembly may be adjustable.

In one embodiment, the first base bracket is connected with the second base bracket via a pair of retractable guiding rail such that the second base bracket is movable between a retracted position and an extended position away from the retracted position along a lengthwise direction.

In another embodiment, the first base bracket includes a first supporting portion having a first receiving slot, the second base bracket includes a second supporting portion having a second receiving slot, and the second receiving slot is recessed from a first surface of the second supporting portion.

In another embodiment, the second base bracket may include base, and the second supporting portion pivotally connects to the base. At the unfolded position, the second supporting portion may be pivoted at an angle from a first position adjacent to the first base bracket to a second position to increase a length of the docking assembly. The second supporting portion may include a second surface opposing to the first surface and a third receiving slot recessed from the second surface.

According to yet another aspect of the present disclosure, a vehicle is provided. The vehicle comprises a vehicle structural member; a docking apparatus positioned in a trunk of the vehicle to receive a personal transportation device. The docking apparatus comprises a mounting bracket connected to the vehicle structural member; and a docking assembly pivotally connected to the mounting bracket. The docking assembly includes a first base bracket and a second base bracket moveable relative to the first base bracket along a lengthwise of the docking assembly. The first base bracket has a first receiving slot, and the second base bracket has a second receiving slot. The docking assembly is pivotal between a folded position and an unfolded position. The second base bracket of the docking assembly is at a retracted position at the folded position.

In one embodiment, the docking apparatus may be positioned adjacent to a rear row seat of the vehicle and the docking assembly may be folded to the rear row seat at folded position, and may be positioned adjacent to a trunk floor of the vehicle at the unfolded position.

In another embodiment, the first base bracket may include a first base and a first supporting portion mounted onto the first base. The first receiving slot may be positioned on the first supporting portion, and the first supporting portion may include a main body and a pair of arms extending from the main body. The main body and the pair of arms define a receiving opening, and the second base is received in the receiving opening at the retracted position.

In another embodiment, the second base bracket may include a second base and a second supporting portion pivotally connected to the second base between a first position and a second position. The second supporting portion may include a first surface, and the second receiving slot is recessed from the first surface.

In another embodiment, the second supporting portion may further include a second surface opposing to the first surface and a third receiving slot is recessed from he second surface.

In another embodiment, the personal transportation device is a two-wheeler.

One or more advantageous features as described herein are believed to be readily apparent from the following detailed description of one or more embodiments when taken in connection with the accompanying drawings.

### BRIEF DESCRIPTION OF DRAWINGS

Example embodiments will be more clearly understood from the following brief description taken in conjunction with the accompanying drawings. The accompanying drawings represent non-limiting, example embodiments as described herein

FIG. 1 depicts a partial view of a vehicle according to one embodiment of the present disclosure, illustrating a docking apparatus being at a folded position and an unfolded position in a trunk of the vehicle.

FIG. 2 depicts a perspective view of the docking apparatus in FIG. 1.

FIG. 3 depicts a partially exploded view of the docking apparatus in FIG. 2.

FIG. 4 depicts a perspective view of the docking apparatus in FIG. 2 at an extended position.

FIG. 5 depicts another perspective view of the docking apparatus in FIG. 4, illustrating a second supporting portion at a second position.

FIG. 6 depicts another perspective view of the docking apparatus in FIG. 5, illustrating a two-wheeler being positioned on the docking apparatus.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

The disclosed docking apparatuses will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various docking apparatuses are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

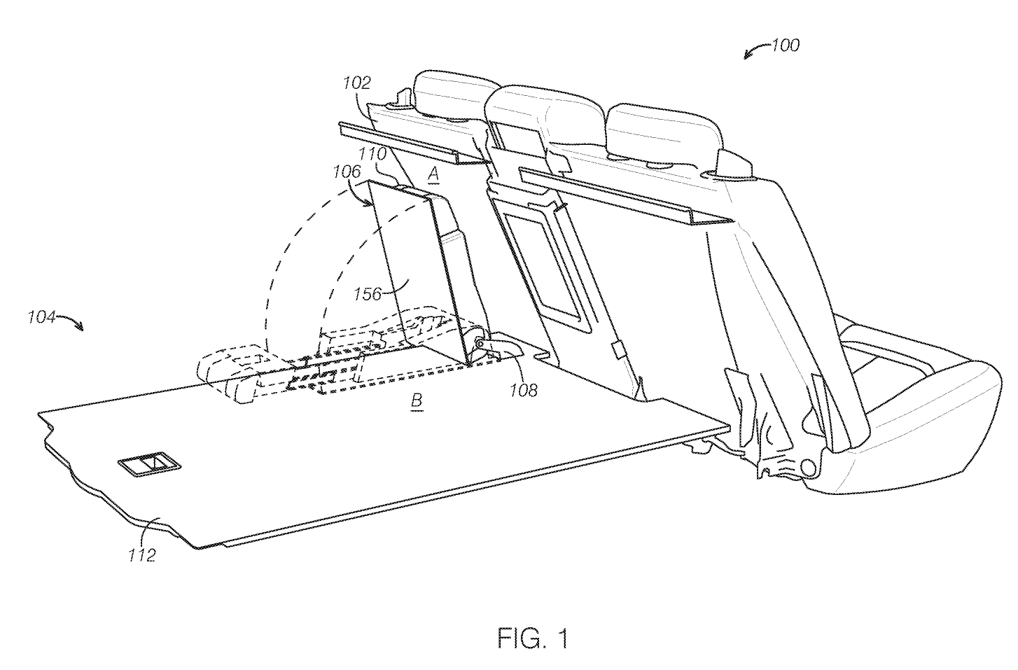

FIG. 1 depicts a partial view of a vehicle 100 according to one or more embodiments of the present disclosure, which shows a rear row seatback 102 of the vehicle and a vehicle trunk 104 positioned at the back of the rear row seatback 102. To solve the last mile issue, a driver may place personal transportation device or a two-wheeler such as an e-bike or an e-scooter in the vehicle trunk 104 such that the driver can ride the personal transportation device from a parking lot to a destination as needed. In one or more embodiments and as depicted in FIG. 1, a docking apparatus 106 is provided in the vehicle trunk 104 and connected to a vehicle structural member such as a vehicle sheet metal for securing the two-wheeler. In one or more embodiments, the docking apparatus may include a mounting bracket 108 and a docking assembly 110 pivotally connected to the bracket 108 and is pivotal to different positions. FIG. 1 shows the docking assembly 110 at a folded position A when not in use in a solid line, and the docking assembly 110 at an unfolded position B pivotal a from the folded position A when in use in a dash line. In one or more embodiments, the docking apparatus 106 is positioned adjacent to the rear seat 102 and may be folded onto the rear seat 102 at the folded position A. The docking assembly 110 is positioned adjacent to a trunk floor 112 at unfolded position B. Further, the docking assembly 110 may be pivotal between the folded position A adjacent to the rear seatback 102 and the unfolded position B adjacent to the trunk floor 112. As the docking assembly 100 can be folded to the rear seat, it takes a small space. In one or more embodiments, the docking assembly 110 may be detachably connected to the bracket 108 such that it may be taken out when not in use.

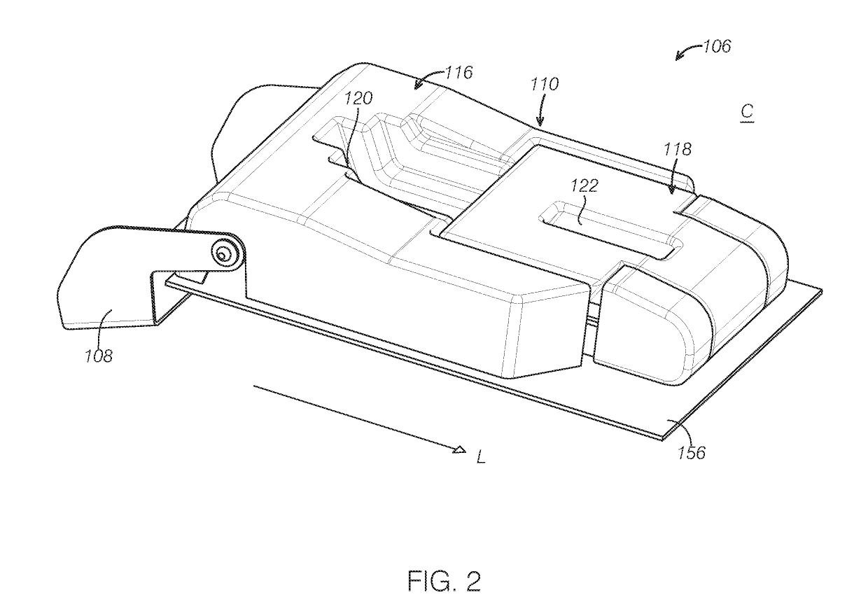

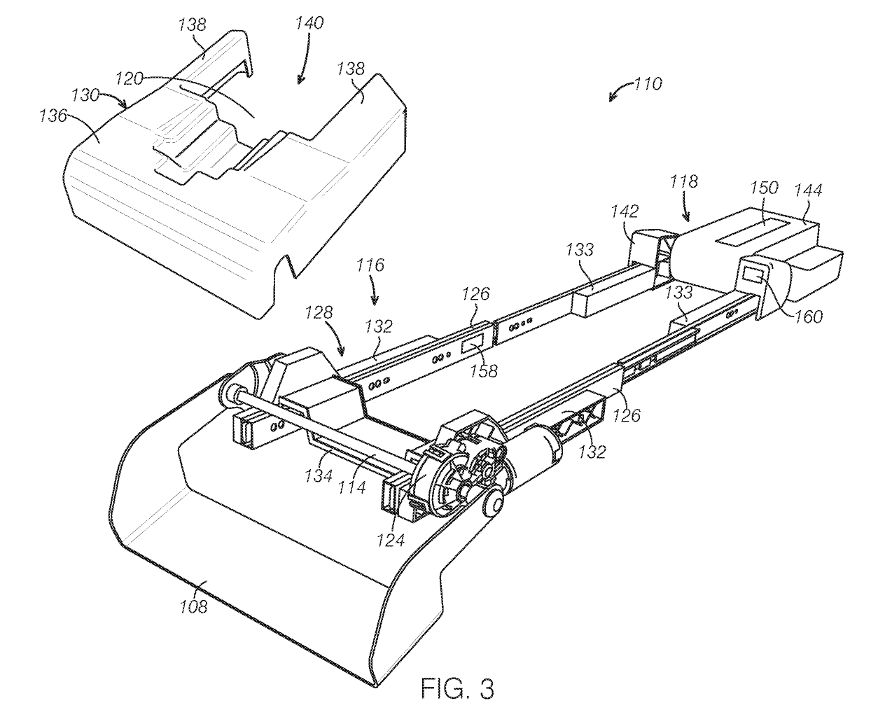

Referring to FIGS. 2 and FIG. 3, FIG. 2 depicts a perspective view of the docking apparatus 106 at a retracted position C. FIG. 3 depicts a partially exploded view of the docking assembly 110 at an extended position. In one or more embodiments, the docking apparatus 106 may include a mounting bracket 108 and a docking assembly 110 pivotally connected to the mounting bracket 108. The docking assembly 110 may be connected to the mounting bracket 108 via a pivotal pin 114. In one or more embodiments, the docking assembly 110 may include a first base bracket 116 and a second base bracket 118 moveable relative to the first base bracket 116. The first base bracket 116 has a first receiving slot 120, and the second base bracket 118 has a second receiving slot 122. In one or more embodiments, the second base bracket 118 is movable relative to the first base bracket 116 along a length direction L such that the length of the docking assembly 110 is adjustable to accommodate the articles with different sizes. In some embodiments, the first receiving slot 120 and the second receiving slot 122 together may be used to receive an article, such as a two-wheeler. In one or more embodiments, the docking apparatus 106 may further include an electric motor 124 positioned in the first base bracket 116 and connected to the pivotal pin 114 to drive the docking assembly 110 and a switch (not shown) positioned adjacent to a trunk opening so as to actuate the electric motor 124 to move the docking assembly 110 to the unfolded position or folded when necessary.

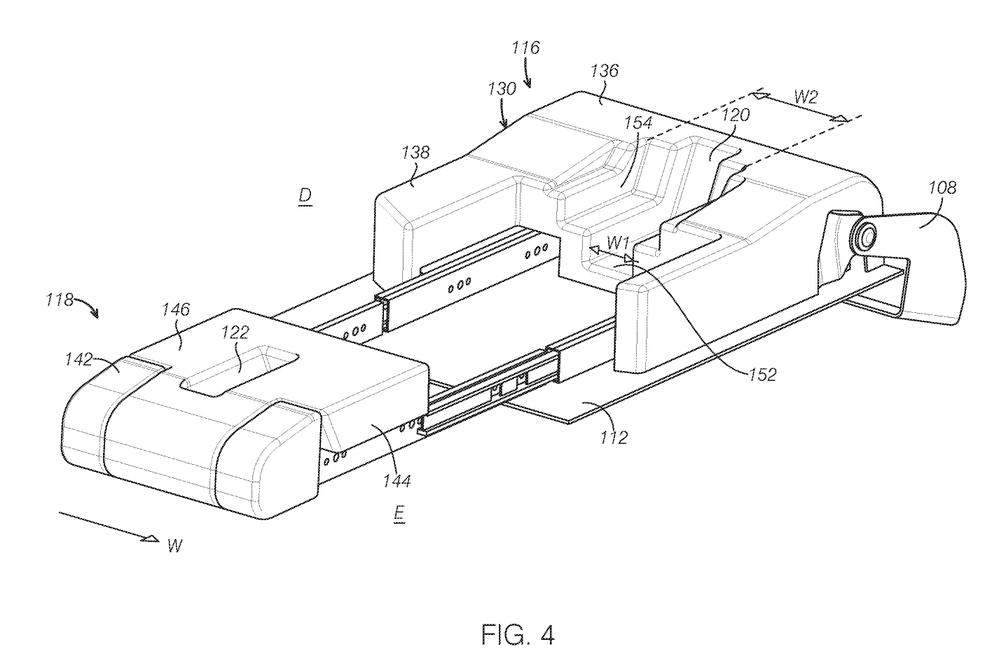

In one or more embodiments, the first base bracket 116 and the second base bracket 118 are connected via a pair of retractable guiding rail 126 to move between the retracted position C shown in FIG. 2 and the extended position D as shown in FIG. 4 along the length direction L (i.e., away from the retracted position C). In one or more embodiments, the docking assembly 110 is disposed at the retracted position C at the folded position A shown in FIG. 1.

Further referring to FIG. 3 and with further reference to FIG. 4, the first base bracket 116 may include a first base 128 and a first supporting portion 130 positioned on the first base 128. The first receiving slot 120 is positioned in the first supporting portion 128. In one or more embodiments, the first base 128 further includes a pair of longitudinal rails 132 and a lateral rail 134 connecting with the longitudinal rails 132. In one or more embodiments, the pair of guiding rails 126 are positioned between the pair of longitudinal rails 132 and under the lateral rails 134 to save a space.

Continuing with FIG. 3, the docking assembly 110 may include a locking device 158 for locking the guiding rail 126 at the extended position. In one or more embodiments, the locking device 158 may lock the guiding rails 126 at various positions to accommodate different size of two-wheelers. It should be understood that the locking device 158 may be any suitable device being able to lock the guiding rails 126.

The first supporting portion 130 may include a main body 136 and a pair of arms 138 extending from the main body 136. The main body 136 and the pair of arms 138 define a receiving opening 140. The second base bracket 118 may at least partially be received in the receiving opening 140 when at the retracted position C shown in FIG. 2. When not in use, the second base bracket 118 may be retracted and received in the receiving opening 140, and the docking assembly 110 may maintain the retracted position when it is folded onto the rear seat 102 to the save space.

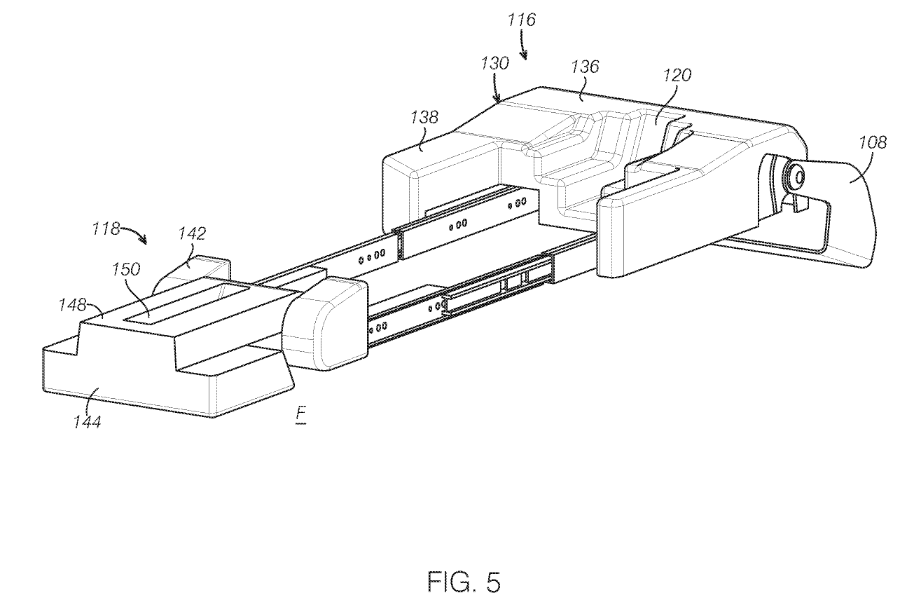

Referring to FIG. 4 and with further reference to FIG. 3, in one or more embodiments, the second base bracket 118 may include a second base 142 and a second supporting portion 144 pivotally connected to the second base 142. The second supporting portion 144 may be pivoted from a first position E shown in FIG. 4 at an angle to a second position F shown in FIG. 5. The second base 142 further includes a pair of longitudinal rail 133 slidably connected to the guiding rails 126. The second supporting portion 144 of the second base 142 may be connected via a pivot between the longitudinal rail 133 or any other suitable pivotal connection. Furthermore, when at the unfolded portion, the second supporting portion 144 may pivot at an angle from a first position adjacent to the first base 116 to a second position F to increase a total length of the docking assembly 110. In one or more embodiments, the angle may about be 180 degrees. It should be understood that the angle may be varied based on the profile of the trunk floor 112, for example, the angle being greater or less than 180 degrees. In one or more embodiments, the second base bracket 118 may include a locking device 160 for locking the second supporting portion 144 at an angle for example at a range between 10 degrees and 90 degrees relative to the vehicle floor. The locking device 160 may be a gear, a spring, a damper or any suitable locking device positioned on the pivotal pin. In some embodiments, the second supporting portion 144 may be positioned to a predetermined angle with the vehicle floor to prevent a wheel from slipping out.

The second supporting portion 144 may include a first surface 146 from which the second receiving slot 122 is recessed. At the unfolded position C or the extended position D, the first receiving slot 120 and the second receiving slot 122 together form receiving portions for accommodating an article such as a two-wheeler and limiting movement of the article.

Referring to FIGS. 4-5, in one or more embodiments, the second supporting portion 144 further includes a second surface 148 opposing to the first surface 146 and a third receiving slot 150 recessed from the second surface 148. At the position F showed in FIG. 5, the second supporting portion 144 is rotated about 180 degrees such that a distance or a length between the second supporting portion 144 and the first supporting portion 130 is increased to accommodate a two-wheeler with different wheel-bases. In other words, the third receiving slot 150 is positioned further away from the first receiving slot 120 than the second receiving slot 122. In one or more embodiments, the second receiving slot 122 and the third receiving slot 150 may differ in size to accommodate the wheels with different sizes.

Further, in one or more embodiments, the first receiving slot 120 of the first supporting portion 130 has an opening toward the second base bracket 118. Two side walls of the first receiving slot 120 have stepped shapes and include a first slot 152 and a second slot 154 above the first slot 152. The first slot 152 has a first width W1, and the second slot 154 has a second width W2 greater than the first width W1 Thus, the first receiving slot 120 may accommodate a wheel with different widths. In an alternative embodiment, the first receiving slot 120 may be a closed slot surrounding by walls along its perimeter.

In one or more embodiments, the second receiving slot 122 of the second supporting portion 144 may be a closed recess with a certain depth configured to accommodate a wheel and prevent the wheel from going out when driving on the bumpy road or sudden braking. In some embodiments, the second receiving slot 122 may have an opening toward the first base bracket 116. In some embodiments, the second receiving slot 122 may have a structure similar to the first receiving slot 120.

In this way, the first receiving slot 120, the second receiving slot 122, the third receiving slot 150 and the pair of guiding rail 126 between the first base bracket 116 and the second base bracket 118 may form various combinations to accommodate different size of wheels.

In one or more embodiments, a first cushion layer and a second cushion layer may be disposed on a surface of the first receiving slot and the second receiving slot, respectively. The first cushion layer and the second cushion layer may be made from noise-absorbing materials. The first cushion layer and the second cushion layer may also have a rough surface to reduce a movement of the wheel in the first receiving slot and the second receiving slot.

The first base, the first supporting portion, the second base, the second supporting portion, the longitudinal rails and the guiding rails may be made from plastic materials or other material with certain stiffness. In some embodiments, the guiding rails may be made from metallic material.

Referring to FIG. 2, the docking apparatus 106 further includes a panel 156 positioned at the bottom of the first base bracket 116. In one or more embodiments, the panel 156 may contact the trunk floor 112 to support a whole docking assembly 110 and may be pivoted with the docking assembly 110 to the folded position to prevent the docking assembly 110 from being collided with articles in the trunk.

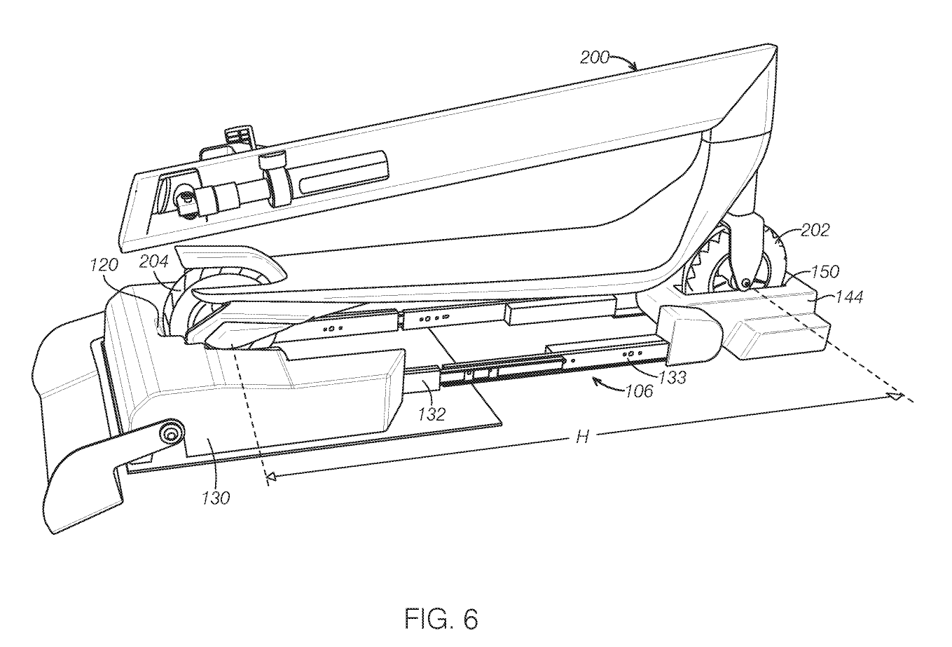

Referring to FIG. 6, a two-wheeler 200 is positioned on the docking apparatus 106. The two-wheeler 200 includes a front wheel 202 and a rear wheel 204, and a wheel-base between the front wheel 202 and the rear wheel 204 is H. In one or more embodiments, the front wheel 202 is positioned in the third receiving slot 150 of the second supporting portion 144, and the rear wheel 204 is positioned in the first receiving slot 120 of the first supporting portion 130. However, in other embodiments, for example when the wheel-base H is relative small, the front wheel 202 is positioned in the second receiving slot 122 of the second supporting portion 144, and the rear wheel 204 is positioned in the first receiving slot 120 of the first supporting portion 130. Further, the length of the guiding rail 126 may be adjusted to accommodate the two-wheeler 200 with different wheel base H when necessary.

It should be understood that a two-wheeler may be placed in the docking apparatus in different ways. For example, the rear wheel 204 may be positioned in the first receiving slot 120 of the first supporting portion 130, while the front wheel 202 may be positioned between the longitudinal rails 132, 133. In another application, the second supporting portion 144 may be locked at a position with an angle relative to the vehicle floor such that the two-wheeler will not move rearward. That is, the docking apparatus may further accommodate a two-wheeler with different wheel base H.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions.

The following claims particularly point out certain combinations and subcombinations regarded as novel and non obvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application.

1. A docking apparatus to hold an article, comprising:
a docking assembly to be pivotally connected to a mounting bracket wherein the docking assembly includes a first base bracket and a second base bracket moveable relative to the first base bracket, the first base bracket includes a first receiving slot, and the second base bracket includes a second receiving slot.

2. The docking apparatus of the claim 1, wherein the docking assembly is connected to the mounting bracket via a pivotal pin.

3. The docking apparatus of the claim 2, further comprising an electric motor positioned within the first base bracket and connected to the pivotal pin to drive the docking assembly.

4. The docking apparatus of the claim 1, wherein the first base bracket is connected with the second base bracket via a pair of retractable guiding rails such that the second base bracket is movable between a retracted position and an extended position away from the retracted position along a lengthwise direction.

5. The docking apparatus of the claim 4, wherein the first base bracket includes a first base and a first supporting portion positioned on the first base, and wherein the first receiving slot is positioned in the first supporting portion.

6. The docking apparatus of the claim 5, wherein the first base further includes a pair of longitudinal rails and a lateral rail connecting with the pair of longitudinal rails.

7. The docking apparatus of the claim 1, wherein the first supporting portion includes a main body and a pair of arms extending from the main body, and wherein the main body and the pair of arms define a receiving opening and the second base bracket is at least partially received in the receiving opening at the retracted position.

8. The docking apparatus of the claim 1, wherein the second base bracket includes a second base and a second supporting portion pivotally connected to the second base, and wherein the second supporting portion is capable of being pivoted at an angle from a first position to a second position, and the second supporting portion includes a first surface, and the second receiving slot is recessed from the first surface.

9. The docking apparatus of the claim 8, wherein the second supporting portion further includes a second surface opposing to the first surface and a third receiving slot is recessed from the second surface.

10. The docking apparatus of the claim 9, wherein the second receiving slot and the third receiving slot differ in size.

11. The docking apparatus of the claim 1, further comprising a panel positioned at the bottom of the first base bracket.

12. A docking apparatus to hold a personal transportation device in a vehicle, comprising:
a mounting bracket; and
a docking assembly pivotally connected to the mounting bracket, wherein the docking assembly is configured to pivot between a folded position adjacent to a seatback and an unfolded position adjacent to a trunk floor, and includes a first base bracket and a second base bracket moveable relative to the first base bracket along a lengthwise direction such that a length of the docking assembly is adjustable.

13. The docking apparatus of the claim 12, wherein the first base bracket is connected with the second base bracket via a pair of retractable guiding rail such that the second base bracket is movable between a retracted position and an extended position away from the retracted position along a lengthwise direction.

14. The docking apparatus of the claim 13, wherein the first base bracket includes a first supporting portion having a first receiving slot, the second base bracket includes a second supporting portion having a second receiving slot, and the second receiving slot is recessed from a first surface of the second supporting portion.

15. The docking apparatus of the claim 14, wherein the second base bracket includes a base, and the second supporting portion pivotally connects to the base; wherein, at the unfolded position, the second supporting portion is pivotable at an angle from a first position adjacent to the first base bracket to a second position further away from the first base bracket to increase a length of the docking assembly; and wherein the second supporting portion includes a second surface opposing to the first surface and a third receiving slot recessed the second surface.

16. A vehicle, comprising:
a vehicle structural member:
a docking apparatus positioned in a trunk of the vehicle to receive a two-wheeler, the docking apparatus comprising:
a mounting bracket connected to the vehicle structural member; and
a docking assembly pivotally connected to the bracket, wherein the docking assembly includes a first base bracket and a second base bracket moveable relative to the first base bracket along a lengthwise of the docking assembly, wherein the first base bracket has a first receiving slot, and the second base bracket has a second receiving slot; wherein the docking assembly is pivotable between a folded position and an unfolded position, and the second base bracket of the docking assembly is at a retracted position when the docking assembly is at the folded position.

17. The vehicle of the claim 16, wherein the docking apparatus is positioned adjacent to a rear row seat of the vehicle and the docking assembly is folded to the rear row seat at the folded position, and is positioned adjacent to a trunk floor of the vehicle at the unfolded position.

18. The vehicle of claim 16, wherein the first base bracket includes a first base and a first supporting portion mounted onto the first base, wherein the first receiving slot is positioned in the first supporting portion, wherein the first supporting portion includes a main body and a pair of arms extending from the main body, and wherein the main body and the pair of arms define a receiving opening, and the second base is received in the receiving opening at the retracted position.

19. The vehicle of the claim 18, wherein the second base bracket includes a second base and a second supporting portion pivotally connected to the second base between a first position and a second position, and wherein the second supporting portion includes a first surface, the second receiving slot is recessed from the first surface.

20. The vehicle of the claim 19, wherein the second supporting portion further includes a second surface opposing to the first surface and a third receiving slot recessed from the second surface.
